(19) United States
(12) Patent Application Publication
(10) Pub. No.: US 2016/0291261 A1
(43) Pub. Date: Oct. 6, 2016

(54) OPTICAL FIBER CONNECTOR WITH OPTICAL PATH DIRECTION CHANGER

(71) Applicant: SENKO Advanced Components (HK) Ltd., Hong Kong (HK)

(72) Inventors: Kenji IZUMI, Hong Kong (HK); Zhendong NI, Shenzhen (CN); Zhenhua LI, Shenzhen (CN)

(21) Appl. No.: 14/676,786

(22) Filed: Apr. 1, 2015

(51) Int. Cl. G02B 6/38; G02B 6/42

(52) U.S. Cl. CPC G02B 6/3839; G02B 6/4243

(57) ABSTRACT

An optical path direction changing optical fiber connector, comprising: a base having an optical fiber mechanical splice at one edge of the base for securing a first end of an optical fiber ribbon; a retention block having a curved surface for guiding a portion of the optical fiber ribbon laid upon thereof, wherein the curved surface curving from a first end to a second end of the optical fiber ribbon such that the first end being at a bending angle to the second end of the optical fiber ribbon, wherein the curved guiding surface having a curvature radius of no more than approximately 2 mm, and wherein the retention block being positioned on top of the base; and a cover for covering the retention block and retaining the portions of the optical fiber ribbon laid upon the curved guiding surface of the retention block.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention generally relates to a connection device for joining of optical fiber, and more particularly to an optical fiber connection device that changes the direction of the optical fiber or joins the optical fibers at an angle.

### BACKGROUND

In optical communication systems, optical transmission between communication equipment is mostly facilitated by optical fibers. Optical fiber connectors are used at the light receiving or emitting ends of an optical fiber to interface optical communication equipment or to join two optical fibers end-to-end. Under certain conditions, an optical fiber is required to be laid in parallel or at angle to the light receiving or emitting surface of a connection interface. This can be achieved by either bending the optical fiber or deploying light reflecting mirror to change the direction of the optical path. However, the use of mirror would necessary cause light to propagate outside of the optical fiber medium and causing possibly diffusional losses.

With the miniaturization of equipment, there are rising demands for direction changing optical fiber connectors. And to accommodate the increasingly limited space, the size of these optical fiber connectors becomes a critical factor in the installation and operation of optical communication systems.

The U.S. Pat. No. 8,235,604 discloses an optical connector for connecting the end face of an optical fiber ribbon on a substrate, which comprises an arc-shaped guiding face for the optical fiber ribbon. Although the claimed optical connector allows the optical fiber ribbon to be bent along the guiding face, the optical fiber ribbon is allowed to stray freely from the curvature of the guiding face, thus an optical path direction and the exact bending angle of the optical fiber cannot be fixed.

The U.S. Pat. No. 8,376,633 discloses an optical path changer component. But this component is also apparently balky and with fiber-exposing (hollow portion 4) part not ideal for fixing an optical path direction and the exact bending angle of the optical fiber.

### SUMMARY OF THE INVENTION

It is an objective of the present invention to provide an optical fiber connector that changes the optical path direction of the connecting optical fiber. It is a further objective of the present invention to provide such optical fiber connector that is compact in size.

In accordance to one embodiment of the present invention, a direction changing optical fiber connector is provided, the optical fiber connector comprising: a base having an optical fiber mechanical splice at one edge of the base for securing a first end of one of one or more optical fibers of an optical fiber ribbon; a retention block having a curved guiding surface for guiding a portion of the optical fiber ribbon laid upon thereof, wherein the curved guiding surface curving from a first end of the optical fiber ribbon to a second end of the optical fiber ribbon such that the first end of the optical fiber ribbon being at a bending angle to the second end of the optical fiber ribbon, wherein the curved guiding surface having a curvature radius of no more than approximately 2 mm, and wherein the retention block being positioned on top of the base; and a cover for covering the retention block and retaining the portions of the optical fiber ribbon laid upon the curved guiding surface of the retention block.

### BRIEF DESCRIPTION OF THE DRAWINGS

Embodiments of the invention are described in more detail hereinafter with reference to the drawings, in which:

FIG. 1A shows a perspective view of the assembled optical fiber connector in accordance to one embodiment of the present invention;

FIG. 1B shows a bottom view of the assembled optical fiber connector in accordance to one embodiment of the present invention;

FIG. 1C shows a back view of the assembled optical fiber connector in accordance to one embodiment of the present invention;

FIG. 1D shows a side view of the assembled optical fiber connector in accordance to one embodiment of the present invention;

FIG. 1E shows a front view of the assembled optical fiber connector in accordance to one embodiment of the present invention;

FIG. 1F shows a top view of the assembled optical fiber connector in accordance to one embodiment of the present invention;

FIG. 2A shows a perspective view of the base of optical fiber connector in accordance to one embodiment of the present invention with an optical fiber ribbon secured there within;

FIG. 2B shows another perspective view of the base of optical fiber connector in accordance to one embodiment of the present invention;

FIG. 3A shows a perspective view of the retention block of optical fiber connector in accordance to one embodiment of the present invention; and

FIG. 3B shows another perspective view of the retention block of optical fiber connector in accordance to one embodiment of the present invention.

### DETAILED DESCRIPTION OF THE INVENTION

In the following description, apparatuses for connecting optical fibers and changing optical path directions of optical fibers and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

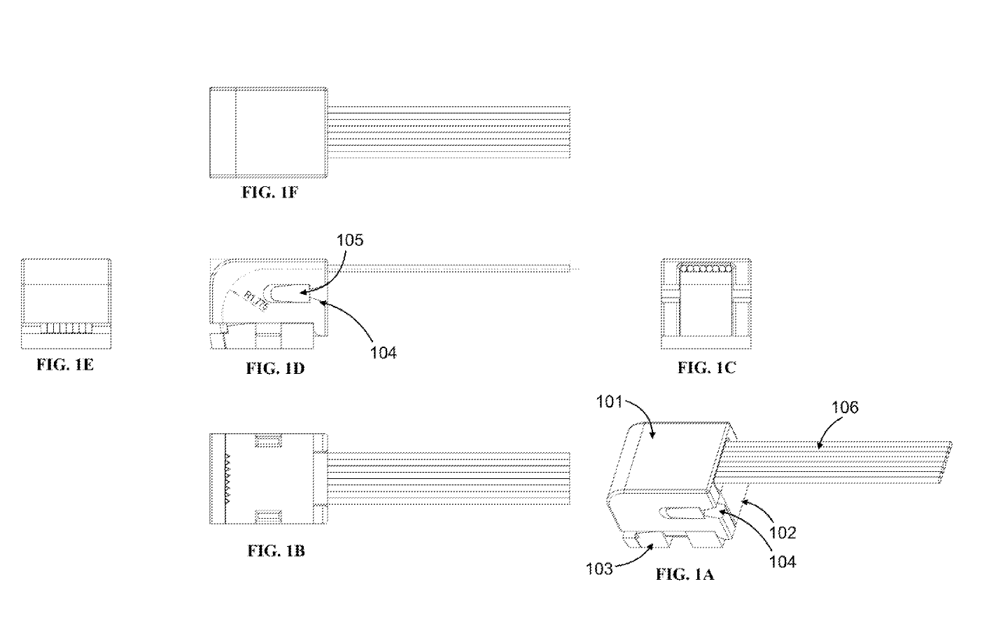

Referring to FIGS. 1A-1F. In accordance to one embodiment of the present invention, an optical path direction changing optical fiber connector for one or more optical fibers is provided, comprising: a cover 101, a retention block 102, and a base 103. The optical path direction changing optical fiber connector can be used to connect a single optical fiber or a ribbon of array of optical fibers. For illustration purposes, a ribbon of array of optical fibers 106 is shown in the drawings but one or more individual optical fibers can be used in place of the ribbon of array of optical fibers without deviating from the concept of the present invention. The optical fibers of the optical fiber ribbon can be 125 μm optical fibers, 165 μm optical fibers, or other optical fibers comparable in size.

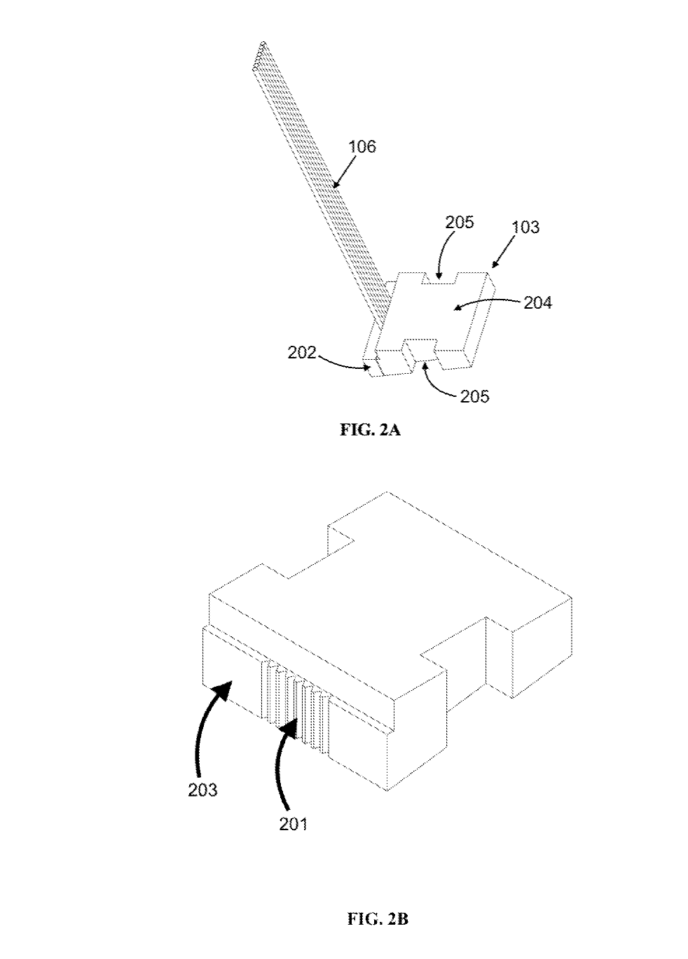

Referring to FIGS. 2A-2B. The base 103 provides an optical fiber mechanical splice at one edge of the base 103 for securing a first end of the optical fiber ribbon. One or more grooves 201 are provided on a first wall 203 of the one edge of the base 103. To secure the optical fiber ribbon, each of the one or more grooves 201 is to hold the one of one or more optical fibers of the optical fiber ribbon. The portions of the optical fibers that are held in the grooves are stripped of their buffers. The grooves 201 can be V-shaped, U-shaped, or in any other suitable shape, but preferably in V-shape. The grooves 201 extend vertically in perpendicular to the top horizontal surface 204 of the base 103. A lid 202 is provided. With the optical fibers of the optical fiber ribbon being held in the grooves 201, a second wall on one edge of the lid 202 is arranged to face directly opposite to the first wall 203 and be pressed on to the optical fibers of the optical fiber ribbon. The first end of the optical fibers of the optical fiber ribbon is then be clamped in between the first wall 203 and the second wall and secured within the grooves 201.

In one embodiment, UV glue is used to glue the portions of the optical fibers of the optical fiber ribbon held in the grooves 201 to the grooves 201 and the first wall 203 to the second wall together with the portions of the optical fibers of the optical fiber ribbon in between. Alternatively, other adhesive means or mechanical holding means can be used in place of UV glue.

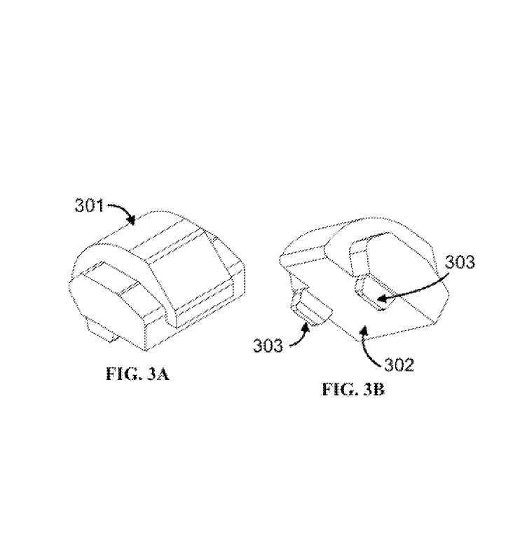

Referring to FIGS. 3A-3B. The retention block 102 is having a bottom surface 302 and a curve surface 301. To assemble the presently claimed optical fiber connector, the retention block 102 is to be positioned on the base 103 with two optional bottom protrusions 303 fitting into two optional side notches (205 in FIG. 2) one on each of the two opposing sides of the base 103. The retention block 102 is oriented to have the curve surface 301 facing away from the side of the base 103 having the optical fiber mechanical splice with the first end of the optical fiber ribbon facing away from the retention block 102.

The curve surface 301 serves as a guiding surface for the optical fiber ribbon laid upon thereof to change its optical path direction from a first direction, which is the direction of light leading into or out from the first end of the optical fibers of the optical fiber ribbon 106, to a second direction, which is at, for instance, 90 degree bending angle to the first direction. Other bending angles of less than 90 degree are also possible. In one embodiment, the curvature of the curve surface 301 has a radius of approximately 1.775 mm. Other curvatures of larger radiuses, but a curvature of no more than 2 mm radius allows the present invention to achieve a distinct advantage of being compact in size.

In one embodiment, epoxy or super glue is used to glue the bottom surface 302 of the retention block 102 to the top horizontal surface 204 of the base 103. Alternatively, other adhesive means or mechanical holding means can be used in place of epoxy.

Referring again to FIGS. 1A-1F. The cover 101 has a closed top and front sides and an open bottom and rear sides. To assemble the presently claimed optical fiber connector, the cover 101 is to be placed over and cover the retention block 102, securing the portions of the optical fiber ribbon retained upon the curved surface 301 of the retention block 102.

In one embodiment, the cover 101 is to be first positioned with the open bottom side on the top horizontal surface 204 of the base 103 and with a snap-on type mechanical latch, hook, or clip, other adhesive means, or mechanical holding means, attach the cover 101 to the base 103. The cover 101 is oriented to have its closed front side faces away from the side of the base 103 having the optical fiber mechanical splice with the first end of the optical fiber ribbon facing away from the cover 101. Then the retention block 102 is to be inserted from the open rear side of the cover 101 into the cavity formed by the cover 101 and the base 103 with the curved surface 301 facing in and its bottom surface 302 facing the base 103. The retention block 102 is inserted until its optional side locking protrusions 105 are fasten to the clasps 104 on the sides of the cover 101. The optical fiber ribbon is secured within the space between the interior of cover 101 and the curved surface 301 of the retention block 102 and extends out from the open rear side of the cover 101.

In another embodiment, the cover 101 is to be placed over the retention block 102 that is already secured on to the base 103 with the a portion of the optical fiber ribbon contained within the cover 101. The cover 101 is oriented to have its closed front side faces away from the side of the base 103 having the optical fiber mechanical splice with the first end of the optical fiber ribbon facing away from the cover 101. Then a snap-on type mechanical latch, hook, or clip is used to attach the bottom of the cover 101 to the top horizontal surface 204 of the base 103. Alternatively, other adhesive means or mechanical holding means can be used in place of epoxy.

With the curvature radius of the curved surface 301 of the retention block 102 as short as 1.775 mm, the entire height of the assembled optical fiber connector can be less than 4 mm or in the extreme case as little as 2 mm.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

1. A direction changing optical fiber connector, comprising:
a base having an optical fiber mechanical splice at one edge of the base for securing a first end of one of one or more optical fibers, the optical fiber mechanical splice comprising:
a first wall and a second wall opposing each other,
wherein the first wall having one or more grooves each for holding the one of one or more optical fibers,
wherein the second wall being for pressing on to each of the one or more optical fibers held, securing the optical fibers held within the grooves, and
wherein the grooves being perpendicular to the base;
a retention block having a curved guiding surface for guiding portions of the one or more optical fibers laid upon thereof,
wherein the curved guiding surface curving from a first end of the one or more optical fibers to a second end of the one or more optical fibers such that the first end of the one or more optical fibers being at a bending angle to the second end of the one or more optical fibers,
wherein the curved guiding surface having a curvature radius of no more than approximately 2 mm, and
wherein the retention block being positioned on top of the base; and
a cover for covering the retention block and retaining the portions of the one or more optical fibers laid upon the curved guiding surface of the retention block;
wherein the retention block is attached the top of the base by an adhesive means or a mechanical holding means.

2. The optical fiber connector of claim 1, wherein the grooves being V-shaped.

3. The optical fiber connector of claim 1, wherein the bending angle is approximately 90 degree.

4. The optical fiber connector of claim 1, having a height measured from the base to top of the cover of no more than approximately 4 mm.

5. The optical fiber connector of claim 1, having a height measured from the base to top of the cover of between approximately 4 mm and approximately 2 mm.

6. The optical fiber connector of claim 1, wherein the one or more optical fibers being arranged in a ribbon of array of optical fibers.

7. The optical fiber connector of claim 1, wherein the one or more optical fibers being 165 μm optical fibers.

8. The optical fiber connector of claim 1, wherein the one or more optical fibers being 125 μm optical fibers.
